(19) United States
(12) Patent Application Publication
(10) Pub. No.: US 2013/0203916 A1
(43) Pub. Date: Aug. 8, 2013

(54) COMPOSITION FOR SURFACE TREATMENT AND METHOD OF MAKING THE SAME

(71) Applicant: Vinay G. Patel, Kansas City, KS (US)

(72) Inventor: Vinay G. Patel, Kansas City, KS (US)

(21) Appl. No.: 13/854,859

(22) Filed: Apr. 1, 2013

Related U.S. Application Data
(63) Continuation-in-part of application No. 12/509,200, filed on Jul. 24, 2009, now abandoned.
(60) Provisional application No. 61/083,572, filed on Jul. 25, 2008.

(51) Int. Cl. C09D 7/12

(52) U.S. Cl. CPC C09D 7/1233
USPC 524/262; 106/287.16

(57) ABSTRACT

A surface treatment composition including statically charged polymeric nanoparticles. The statically charged nanoparticles include hydrogen bonding formed by combination with hydrogen hydroxide. The nanoparticles include one or more pore filling components such as polymeric silicon dioxide. The nanoparticles are encapsulated so as to retain the charge wherein the encapsulant may be a polyacrylate. The charged nanoparticles are retained to the surface to be treated and penetrate most soft and hard surfaces, insulating against oxidation, providing superior protection from soiling, staining and ultra violet degradation. The super smooth surface significantly reduces friction and mitigates static generation. Subsequent applications of the composition bond to previous applications of the composition and improve surface protection.

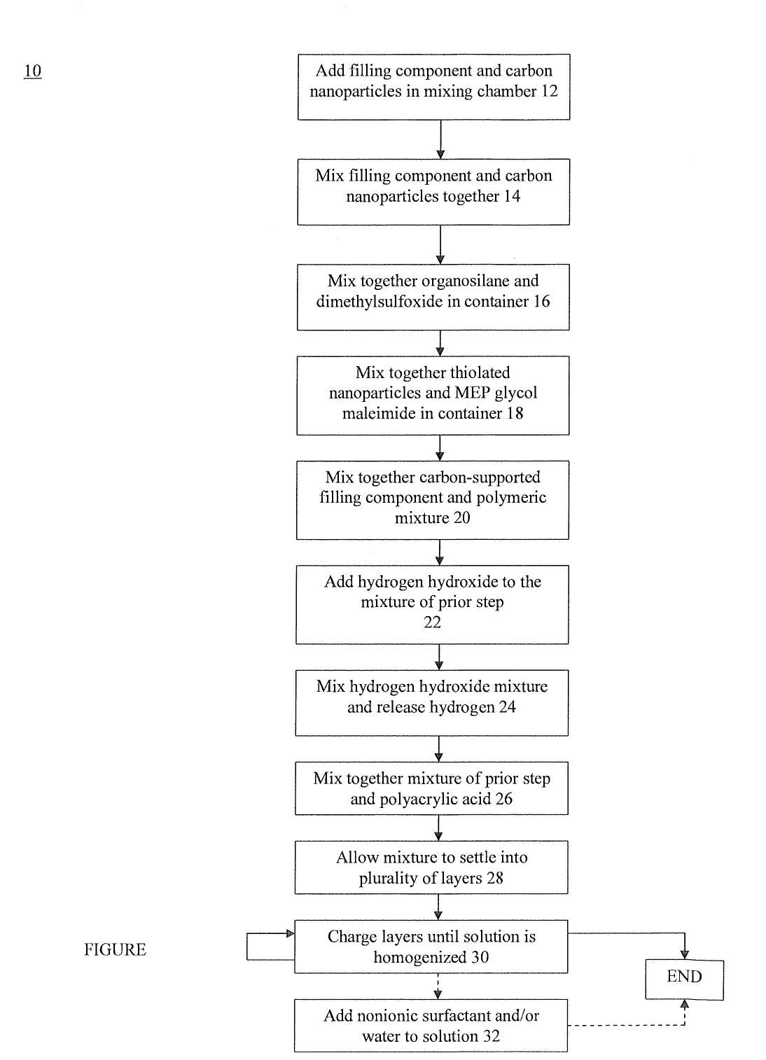

### CROSS REFERENCE TO RELATED APPLICATION

The present invention is a continuation-in-part of, and claims the priority benefit to, U.S. nonprovisional patent application Ser. No. 12/509,200, filed Jul. 24, 2009, entitled “FUSION BONDED NONIONIC SURFACE FINISH AND METHOD OF MAKING THE SAME”, which nonprovisional application is related to, and claims the priority benefit of, U.S. provisional application No. 61/083,572, filed Jul. 25, 2008, entitled “E3—A FUSION BONDED NONIONIC NANO POLYMER SURFACE FINISHING SYSTEM” by the inventor of the present invention. The entire contents of the two applications are incorporated herein by reference.

### BACKGROUND OF THE INVENTION

1. Field of the Invention

The present invention relates to compositions and methods for protecting surfaces. More particularly, the present invention relates to polymer-based surface finishing systems. The present invention is an encapsulated nonionic surface finish composition and method of making the same.

2. Description of the Prior Art

There is a continuing need for coatings, treatments or finishes that protect surfaces against adverse environments. For example, protective coatings are needed for a range of vehicles, including, but not limited to, automobiles. There is also a continuing need for treatments that improve the functionality of the surfaces of structures. For example, lubricants can be used to reduce friction between two surfaces. Preferably, surface treatments should be flexible and adherent under a range of conditions.

Typically, liquid coatings are used as protective coatings, but these suffer from a number of drawbacks, most notably the use of volatile organic compounds (VOCs) as solvents for their preparation and application. An increasing number of restrictions on VOCs has led to development of water-borne and high-solids coatings, the use of which has limitations due to long drying times, slow cure rates, and inadequate weatherability.

Films and coatings comprising fluoro-containing polymers are known and their inertness toward moisture, many solvents, and weathering conditions is known. For example, Teflon™ available from the DuPont Company is a poly(tetrafluoroethylene) compound that has found considerable use as a repellant for rain when incorporated into or spray-applied to clothing, upholstery, and other fabrics. However, fluoro-containing polymers are generally non-polar and do not easily adhere to many common surfaces such as wood, metals, and other polymers. In addition, fluoro-containing polymers generally are more expensive than their hydrocarbon polymer counterparts. Improved, cost-effective, strongly-adhering, long-lasting fluoro-containing polymer protective coatings are continually in demand.

Free-standing protective and/or decorative multi-layer films for outdoor use (e.g., outdoor signs, automobile bodies) are known. Typically, such films comprise an adhesive layer, a film layer that may optionally be pigmented, and an overlay or protective layer. Effective protective films must adhere strongly to the substrate (which is often a metal or an already-coated metal) and withstand challenges from heat, oxidants, solvents, sunlight, scratches, and impinged objects such as hailstones and rocks while maintaining their gloss or other decorative aspects, and, in many cases, be easily removable without leaving residual adhesive. However, such types of treatments are costly and require special attention to the application process.

Most automotive treatment products are use-specific in the sense that they can be used only on one type of surface. For example, although waxes are effective in protecting and restoring automobile paint finishes, they do not work well on most vinyl surfaces. This is because wax clogs the surface indentations creating the roughened surface appearance of the vinyl finish, which in turn detracts rather than enhances the surface appearance of the finish. Polishing agents in the wax only make the problem worse, since they are even more visible than the wax itself.

A common feature of practically all wax-containing auto finish-treating products is that they require significant rubbing and/or buffing to be effective. This is not only time-consuming but also requires significant physical effort. Accordingly, a need also exists for a new auto finish-treating product which can be applied very easily, by simply wiping or other application method, without the rubbing or buffing steps normally required with conventional wax-containing products.

In the same way, auto surface-treating products formulated for use on vinyl and other polymer-based parts are not effective on paint, glass, rubber or metal finishes, while products useful on paint finishes may not be effective on metal, rubber, vinyls or other plastic finishes. In addition, auto surface-treating products formulated for use on exterior polymer-based parts are not effective on surfaces found in the interior portion of an automobile, such as leather, colored plastic, chrome or glass surfaces. Likewise, products used to treat interior surfaces of automobiles, such as leather, are not effective on exterior automobile surfaces, such as paint or metal finishes.

Traditional waxes and polishes that are the most common compositions to treat surfaces are mostly solvent borne, organic based polishing particles, these solvents, when exposed to sun light, evaporate, then the polishing solids abrade off the surface by force of contact with wind or water. In particular, the traditional waxes and polishes are mostly solvent borne suspensions of relatively large organic based polishing particles. The solvents evaporate when exposed to sunlight. The polishing solid particles then evaporate and are abraded off the surface by force of contact with wind, water or contact with other surfaces; or degraded by heat and “cooked” away.

Therefore, what is needed is a finish that is effective as a surface protectant and/or as a surface enhancement, is relatively easy to apply and cost effective. The finish should not harm the surface to which it is applied. What is also needed is a method for making such a finish.

### SUMMARY OF THE INVENTION

It is an object of the present invention to provide a finish that is effective as a surface protectant and/or as a surface enhancement. It is also an object of the present invention to provide such a finish that is relatively easy to apply and is cost effective. The present invention is fabricated to avoid or minimize harm to the surface to which it is applied. Further, it is an object of the present invention to provide a method of making such a finish composition.

The present invention is a solution composition comprising polymeric nanoparticles and hydrogen hydroxide fused together to establish what is referred to herein as a polymeric nano fusion composition. In general, nanoparticles are those particles having at least one dimension that is less than 100 nanometers. For purposes of the present invention, polymeric nanoparticles are approximately about 100 nanometers or smaller, but not specifically limited thereto. Instead, the polymeric nanoparticles of the present invention are any polymeric particles sufficiently small enough to fit within interstices, holes, valleys, etc. of a body having a surface to be finished. They may be about 75 nanometers and may further be about 30-35 nanometers but not limited thereto.

The solution composition of the present invention is formed by fusing together polymeric nanoparticles with hydrogen hydroxide (water) as a hydrogen-bond providing carrier and then encapsulating that fused combination in the manner to be described herein. Each component of the composition, working in concert with the others, provides a surface finish that is more easily and more quickly applied across a broad spectrum of environmental conditions. It is environmentally friendly, hard, more solid and deeper penetrating than conventional finishes. It remains functional to 400° C. and provides significantly greater protection from sun, soil, staining, static and friction than traditional finishes.

The solution composition of the present invention can be used to mitigate static electricity through negative charging of the polymeric nanoparticles during the fabrication process and hydrogen fusion bonding of the particles. The nanoparticles are small enough to penetrate the surface and sub surface of the body to be treated to create a permanent bond by filling nano and micro pores on the top of and inside the surface.

The composition can be used as a dry lubricant, a mold release agent, ultraviolet protection for laminated composites, such as sail boat sails; to improve the “slip” of watercraft through the water and aircraft through the air. It can be used to finish automobile surfaces, other vehicles, boats, airplanes, LCD and plasma TV screens, LED screens, computer screens, and cell/mobile phone screens. It can be used on all precious metals, diamonds, natural and man made stone and all imitation jewelry. Further, it can be used on kitchen counter tops, refrigerators, ovens, microwaves and all household electronic appliances inside and out. It makes the surface of the body treated slick and smooth. It keeps soil and bacteria from penetrating the surface, making future cleaning much easier, faster and helps keep surface sanitary.

The composition is a fusion-bonded nonionic nano polymer surface finishing solution. Fusion bonded UV protected polymeric particles can flow into a surface forming an integral bond with the surface, minimizing the abrasive effect of wind, water or contact with other surfaces. When the water carrier evaporates, the polymer forms a superior, alloy like bond, isolating the surface, and requiring reapplication far less often.

The invention is a fusion-bonded nononic nanopolymer surface finishing system. The nanometer-sized polymeric particles deliver superior penetration and isolation of most soft and hard surfaces, insulating against oxidation, providing superior protection from soiling, staining and ultra violet degradation. The super smooth surface created by adding the present solution composition significantly reduces friction and mitigates static generation. Subsequent applications of the composition are better suited to bond to previous applications of the composition and improve the surfaces protection. The finish reduces friction, repels dust, dirt and moisture, and inhibits oxidation, corrosion, pollution, static, fading and UV damage. It is a water-based fusion structure including polymeric nano particles that delivers the best protection known to any surface, with no environmental harm. The composition may be used to protect most any structure to which it is applied with little to no adverse impact on the environment.

The composition may be used on hard or soft surfaces. It may be used on painted, plated anodized or unfinished metals, fiberglass, Plexiglas, composites, canvas, upholstery, finished or unfinished wood, stone, granite, marble and gemstones. It may be used on cars, consoles, dashboards, windshields, boats, sails, soft sides and windows, awnings, heavy equipment or computer screens, eyeglasses, countertops, bath fixtures, furniture, cabinets, fishing gear, firearms, concrete, tools, lawn mowers, snow equipment, and dump truck beds, but is not limited thereto.

These and other advantages of the present invention will become apparent upon review of the following detailed description, the accompanying drawing and the appended claims.

### BRIEF DESCRIPTION OF THE DRAWING

The FIGURE is a simplified representation of the primary process steps associated with making the composition finish of the present invention.

### DETAILED DESCRIPTION OF THE INVENTION

A solution of the present invention for treating surfaces is made by a process 10 represented in the FIGURE. First, in step 12, a surface pore filling component in powder form and carbon nanoparticles in powder form as carbon nanotubes are placed in a mixing container such as a stainless steel mixing chamber. The surface pore filling component may be a silicon dioxide polymer, a titanium dioxide polymer, a zinc oxide polymer, a cobalt oxide polymer or other material selectable based on the porosity of a surface to be treated. Combinations of surface pore filling components may be combined together and with hydrogen bonding components described herein and encapsulated as described herein to make the solution of the present invention. For example, a single polymeric pore filling component may be employed when the finish is to be used as a surface protectant, such as a car surface finish. In another example, two or more different polymeric pore filling components may be employed when the finish is to be used to establish low surface friction and high ultraviolet resistance, such as a treatment for the wing of an aircraft. In an embodiment of the invention, a silicon dioxide polymer available from Wacker Materials of Germany and referred to as HDK® silicon dioxides, including the hydrophobic and hydrophilic versions, either alone or in a mixture of the two, is suitable as the surface filling component. The carbon nanoparticles provide a substrate and attachment sites for the formation of the solution of the present invention. They are substantially neutral and inert in all respects in the solution product of the present invention.

The ratio of pore filling component to carbon nanoparticles is in the range of about one to about three by volume. In step 14, the pore filling component and the carbon nanoparticles are mixed together for 60 minutes at a temperature of 110 degrees F. to form a carbon-supported pore filling component. A conventional high shear, high speed mixer, such as a Charles Ross and Son Batch High Shear mixer, but not limited thereto, is suitable for that mixing.

In step 16, an interpolymer complex creating component is formed for the purpose of creating an interpolymer complex with the surface pore filling component. Specifically, an organosilane, such as 3-mercaptopropyltrimethoxysilane in powder form, and dimethylsulfoxide in liquid form in a ratio of about one to about three by volume are mixed together in a container separate from the chamber used to mix the surface pore filling component and the carbon nanoparticles. That mixture forms thiolated nanoparticles. In step 18, methoxypolyethylene glycol maleimide in liquid form in a ratio of about one of the methoxypolyethylene to about three of the thiolated nanoparticles by volume is added to the thiolated nanoparticles and that combination is mixed for 40 minutes at a temperature of 105 degrees F. to form a mixture of polymeric nanoparticles of silicon dioxide. The methoxypolyethylene glycol maleimide mixture is a thickening agent and provides the basis for establishing interpolymer complexes with the pore filling component.

In step 20, the silicon dioxide polymeric nanoparticles mixture is combined with the carbon-supported pore filling component, which combination may be made in an existing one of the mixing chamber and the container, such as the mixing chamber, for example. The ratio of polymeric nanoparticles mixture to carbon-supported pore filling component is about one to about 1.5 by volume. The combination is mixed into a semi-gel composition wherein initial organic polymer and pore filling component bonds are initiated. The mixture is allowed to settle and then hydrogen hydroxide in the form of deionized water is added to the mixing chamber in step 22 of the process 10. The amount of deionized water added to the mixture is dependent upon the particular pore filling component used in step 12 and the intended purpose of the solution. In general, the ratio of deionized water to pore filling component is about 1.5 to about one by weight so that the deionized water is about 10% and about 30% by volume of the final composition. The hydrogen hydroxide provides a positive charge in the form of the hydrogen atom released to the mixture. That polymer-hydrogen hydroxide combination is mixed in step 24 at about 95 degrees F. for about 30 minutes. Next, in step 26, a polyacrylic acid is added to the mixing chamber in a ratio of about three polyacrylic acid to about six of the polymer-hydrogen hydroxide combination by weight.

The mixture is retained in the chamber at about room temperature for about 20 minutes per 100 gallons of the composition in process to ensure sufficient removal of excess hydrogen and organo-complex bonding of the silicon dioxide. The mixing is halted and in step 28, the mixture is allowed to settle into five, layers, wherein a first layer of polymer-hydrogen hydroxide is the most dense layer positioned at the bottom of the mixing chamber, a second layer of acrylic acid is the next most dense layer located on the first layer, a third layer of silicon dioxide and hydrogen hydroxide, a fourth layer of dimethylsulfoxide, and a fifth layer of silicon dioxide nano particles and methoxypolyethylene glycol is the lowest density of the five layers and is located in the uppermost region of the mixing chamber. Each of the respect layers of the mixture has characteristics of positive and negative charges.

A first parallel plate of a parallel plate capacitor is inserted in the mixing chamber below and in contact with the first layer of the mixture and a second parallel plate of the parallel plate capacitor is inserted in the mixing chamber above and in contact with the fifth layer of the mixture. Alternatively, the parallel plate capacitor may be prepositioned in the mixing chamber prior to the mixing steps previously described. In step 30 of the process 10, a voltage is applied across the capacitor so that positively charged molecules of the respective layers move toward the negatively charged plate and negatively charged molecules of the respective layers move in the opposing direction to the positively charged plate of the capacitor. Neutral molecules become interspersed through the layers as charged molecules move in opposing directions. The supplied voltage is then removed and the mixture observed for separation into two or more layers.

The process of charging and discharging the plates of the capacitor and observing the mixture for separation is repeated until no separation is observed and the solution composition formed is homogeneous. The homogeneous nature of the composition may optionally be determined by applying a small alternating current to the two plates of the capacitor until they are observed to be fully charged. If the time to accomplish that is greater than a few minutes it can be concluded that the mixture has absorbed substantial charging. The voltage is again applied to the plates to charge them and then re-evaluated. When they can be recharged in 2-3 minutes the mixture has likely been statically charged to its capacity. Once homogeneity is observed and/or determined electrically, the process 10 for making the solution composition is ended.

Optionally, in step 32, one or more nonionic surfactants may be added to the solution composition in the chamber. Such nonionic surfactants may include a hydrophilic section and a hydrophobic section. Alcohol ethoxylates, such as linear ethoxylated alcohol, have been found to be suitable nonionic surfactants to be used in combination with the composition to promote bonding characteristics of the composition and to facilitate the evaporation of any excess components of the mixture described above not required to enhance the effectiveness of the composition. The nonionic surfactant is a small portion of the final composition if added thereto. It may be about 0.5% by weight of the composition. The composition and the surfactant are emulsified together by mixing them together vigorously in the chamber, preferably, but not required, at room temperature. A conventional high shear, high speed mixer known to those of skill in the art may be used for this purpose. This mixing ensures that the composition will remain suspended with the surfactant for an extended period of time. The indicated combination may be emulsified again in the event of any separation that may occur, by repeating the vigorous mixing step. Water may also be used to dilute the combination.

The steps associated with the process 10 form, when using silicon dioxide as the polymeric pore filling component, the solution composition of the present invention that can be used to treat surfaces of the type described herein for the purposes that have been identified. the conditioning of the solution at this temperature enable the polymeric particles to later bond with a broad variety of surfaces, hard and soft, affording exceptional protections without negative impact on the surfaces.

The silicon dioxide component of the composition provides what can be characterized as a non-metallic chemical bond because the difference in electronegativity between the bonding atoms is small. The difference in electronegativity between Si and O is 1.54; by comparison, the difference between H and O is 1.24, and between H and F is 1.78. Further, ordinarily, oxygen has a −2 oxidation state. In hydrogen peroxide (H—O—O—H) for example, each oxygen atom has a −1 oxidation state, because neither oxygen is more electronegative than the hydrogen hydroxide portion of the molecule so they share the bonding electrons equally, one for the left oxygen and one for the right oxygen. Silicon dioxide has 18 valence electrons, without including d-shell electrons in the mix. The structure ::O═:Si═O:: has no formal charge on any atom, and −2 oxidation state on each of the most electronegative atoms is very stable. On the other hand, the structure ::S═:O—O:::, a peroxide, has a formal charge of +1 on the left oxygen and −1 on the right oxygen; the positive formal charge on the most electronegative atom, and the negative formal charge means a higher charge density than zero formal charge. For these reasons it is much less stable than the O═S═O structure of the organosilica polymer component of the solution composition of the present invention using hydrogen hydroxide as a positive charge providing component.

Further, through the process 10, the silicon dioxide nanoparticles have been synthesized through self-condensation of 3-mercaptopropyltrimethoxysilane in dimethylsulfoxide into thiolated nanoparticles with their subsequent reaction with methoxypolyethylene glycol maleimide. The silicon disoxide nanoparticles are capable of forming hydrogen-bonded interpolymer complexes with polyacrylic acid in aqueous solutions under acidic conditions, resulting in larger particles; that is, a thickening of the solution composition wherein the acrylic formed by the release of the acidic hydrogen atom encapsulates the stable charged silicon dioxide particles during the course of mixing and capacitor charge/discharge that occurs in the mixing chamber. The use of hydrogen-bonding interactions allows their more efficient attachment of the nanoparticles to surfaces to be treated. The self-assembled PEGylated silicon dioxide nanoparticles with polyacrylic acid in an aqueous solution was compared to the behavior of linear poly(ethylene glycol). The nanoparticle system creates thicker layers than the poly(ethylene glycol), and a thicker layer is obtained on a polyacrylic acid surface than on a silica surface, because of the effects of hydrogen bonding thereby resulting in better dwell time on the surface for deeper penetration of the pore filling component into the surface.

In one embodiment of the present invention, a solution composition including the components described with respect to the process 10 was applied to a set of golf balls for the purpose of determining whether the finish would reduce the frictional characteristics of the surface of the treated balls. The composition in emulsion form was brushed onto all surfaces of the balls to be treated and allowed to dry by allowing the surfactant to evaporate. A total of 24 identical Titleist NXT Tour golf balls were used in the experiment. Twelve of the balls were untreated and 12 were treated with the surface finish. Each ball was placed on a tee and hit by a golfer qualified to have a handicap of two. The treated and untreated balls were hit alternatively. Their ball speeds, launch angles, spin rates, side spin values, carry distances and total distances were measured. It was determined that the treated balls, on average, gained 4% additional distance and had a spin reduction of 5% when compared to the averages of those characteristics for the untreated balls,

While the invention has been described with specific reference to particular components of the composition and the use of particular steps, it is to be understood that the invention includes all reasonable equivalents.

What is claimed is:

1. A composition for finishing a surface of a structure, the composition comprising a mixture of a plurality of polymeric nanoparticles and hydrogen hydroxide fused together.

2. The composition as claimed in claim 1 wherein the hydrogen hydroxide and the polymeric nanoparticles are combined together in a weight ratio of about 1.5/1 hydrogen hydroxide to polymeric nanoparticles.

3. The composition as claimed in claim 1 wherein the plurality of polymeric nanoparticles comprises one or more types of polymeric materials.

4. The composition as claimed in claim 1 wherein the polymeric nano particles are no more than 75 nanometers in any dimension.

5. The composition as claimed in claim 1 further comprising a nonionic surfactant.

6. The composition as claimed in claim 5 wherein the nonionic surfactant is a linear ethoxylated alcohol.

7. The composition as claimed in claim 5 wherein the nonionic surfactant comprises about 0.5% by weight of the composition.

8. A method for fabricating a composition for finishing a surface of a structure, the method comprising the steps of:
a. mixing together a pore filling component and carbon nanoparticles to form a carbon-supported pore filling component;
b. forming an organosilane mixture;
c. combining the carbon-supported pore filling component and the organosilane mixture together to form a pore filling organosilane mixture;
d. adding hydrogen hydroxide and polyacrylic acid to the pore filling organosilane mixture to form a plurality of layers; and
e. statically charging the layers to homogenize them into the composition.

9. The method as claimed in claim 8 wherein the pore filling component is silicon dioxide.

10. The method as claimed in claim 8 wherein the pore filling component is zinc oxide.

11. The method as claimed in claim 8 wherein the pore filling component includes one or more of silicon dioxide, zinc oxide and titanium dioxide.

12. The method as claimed in claim 8 further comprising the step of merging the composition with a nonionic surfactant.

13. The method as claimed in claim 12 wherein the nonionic surfactant is a linear ethoxylated alcohol.

14. The method as claimed in claim 13 wherein the linear ethoxylated alcohol comprises about 0.5% by weight of the mixture.
